(19) United States
(12) Patent Application Publication
(10) Pub. No.: US 2019/0362442 A1
(43) Pub. Date: Nov. 28, 2019

(54) SYSTEM AND METHOD FOR PREDICTION OF EMAIL ADDRESSES OF CERTAIN INDIVIDUALS AND VERIFICATION THEREOF

(71) Applicant: Shocase, Inc., San Francisco, CA (US)

(72) Inventors: Ronald P. Young, Mill Valley, CA (US); Peter Rugg, New York, NY (US); David Anthony Burgess, Menlo Park, CA (US); Joao Paulo Aumond, San Francisco, CA (US); Robert Walter Kerns, Corte Madera, CA (US)

(73) Assignee: Shocase, Inc., San Francisco, CA (US)

(21) Appl. No.: 16/535,066

(22) Filed: Aug. 7, 2019

Related U.S. Application Data
(63) Continuation of application No. 16/151,327, filed on Oct. 3, 2018, now abandoned.
Application No. 16/151,327 is a continuation of application No. 15/247,577, filed on Aug. 25, 2016, now abandoned.
(60) Provisional application No. 62/210,335, filed on Aug. 26, 2015.

(51) Int. Cl. G06Q 50/00; H04L 12/58; G06Q 10/10; G06N 5/04

(52) U.S. Cl. CPC G06Q 50/01; H04L 51/28; H04L 61/3005; G06N 5/04; G06Q 10/107

(57) ABSTRACT

A method includes obtaining an identifier of an individual. The individual is associated with an entity such that the individual has an email address in a domain corresponding to the entity. The method also includes determining one or more candidate domains such that: the one or more candidate domains potentially correspond to the entity; and the individual potentially has the email address in at least one of the one or more candidate domains. The method further includes determining one or more candidate email addresses in at least one of the one or more candidate domains. The method additionally includes testing the one or more candidate email addresses and the one or more candidate domains to determine the email address of the individual in the domain corresponding to the entity.

### CROSS-REFERENCE TO RELATED APPLICATIONS

This Application claims priority to U.S. Provisional Patent Application Ser. No. 62/210,335, filed Aug. 26, 2015, entitled “System and Method for Prediction of Email Addresses of Certain Individuals and Verification Thereof,” which is hereby incorporated by reference herein in its entirety.

This Application is also related to U.S. application Ser. No. 14/507,003, filed Oct. 6, 2014, entitled “System and Method to Provide Collaboration Tagging for Verification and Viral Adoption” and to U.S. application Ser. No. 14/626,012, filed Feb. 19, 2015, entitled “System and Method to Provide Pre-Populated Personal Profile in a Social Network,” which are hereby incorporated by reference herein in their entireties.

### FIELD OF THE INVENTION

The present invention relates generally to computer software, and more particularly relates to Internet software that drives social networking applications.

### BACKGROUND

There exists prior art in the nature of methods for scanning and analyzing computer systems databases to identify proper names and to match-up data and draw relationships between data. Further there exists prior art describing methods for determining email address formats corresponding to known domain names and generating email address guesses.

Since the development of email in the last century, many inventions have sought to differentiate between personal and company email addresses, to determine the location of the recipient, and to refine the postal address of the recipient and other attributes of the holder of the email address. In addition, it is well known that an email address can serve as a unique personal identifier of a person and such identifiers are often used for purposes of registration and sign-in to digital network systems.

There exist systems and methods for scanning and analyzing documents in a computer database to identify proper names and to match-up names and email/postal addresses. Other systems will analyze domain names in conjunction with known relationships between email addresses and names of companies in order to determine email address format corresponding to known domain names. There is also prior art describing a method for generating email address guesses and using the returned mail feature to test possibilities until a successful address, for an unknown person, is found. These systems generally rely on readily available data in the same database or assume a level of knowledge of the relationships that simplifies the matching of data.

However, there are often times when it is necessary to infer the email address of a person prior to gaining actual knowledge of a person's email address, e.g., prior to his registration on a network system. Such advance identification of a person's email address can be of value in many ways. However, heretofore, there has been no reliable method of email address prediction.

### SUMMARY

An exemplary method, according to an aspect of the invention, includes a step of obtaining an identifier of an individual, wherein the individual is associated with at least one entity such that the individual has an email address in a domain corresponding to the entity. The method also includes a step of determining one or more candidate domains such that: the one or more candidate domains potentially correspond to the at least one entity; and the individual potentially has the email address in at least one of the one or more candidate domains. The method further includes a step of determining one or more candidate email addresses in at least one of the one or more candidate domains, wherein the one or more candidate email addresses comprises the email address which the individual potentially has in the at least one of the one or more candidate domains. The method additionally includes a step of testing the one or more candidate email addresses and the one or more candidate domains to determine the email address of the individual in the domain corresponding to the entity.

### BRIEF DESCRIPTION OF THE DRAWINGS

FIG. 1 shows an overview of the steps involved in predicting and verifying company email addresses.

FIG. 2 shows the steps taken to obtain a personal name and the company name of an employer.

FIG. 3 shows a flowchart to determine company email formats.

FIG. 4 shows a flowchart of steps to predict and verify company email addresses.

FIG. 5 depicts a general overview of an Internet-accessible social network site platform, in accordance with various aspects of the present disclosure.

### DETAILED DESCRIPTION

Illustrative embodiments of the present invention are applicable to computer software, particularly Internet software that drives social networking applications such as a system for social networking and/or social collaborating. Social networks are systems that permit users to become members and as members to utilize the system to communicate and exchange information with other member users. Certain social networks are considered market networks because of their ability and utility in supporting business and commerce while filling market needs for business enterprises. Examples of market networks include Shocase® and LinkedIn®. Shocase® is a registered trademark of Shocase, Inc., San Francisco, Calif., the assignee of the present application. LinkedIn® is a registered trademark of LinkedIn Corporation, Mountain View, Calif.

An exemplary computer system uses unique software algorithms to employ a combination of steps to predict and verify company email addresses for various individuals. The system uses private system data and interrogates public third-party services. This includes but is not limited to searching authoritative sites for domains, the canonicalization of company names and shortened formats, techniques to throttle and anonymize requests, a verification scoring system and filtering through generated blacklists. Thus, an illustrative embodiment includes a system which uses private databases and public third-party data to predict company email address formats and users' email addresses. A series of steps may be employed using unique software algorithms that take supplied person and company names from a variety of sources and determine the company email format. The email addresses for these people are then predicted and are then passed through a verification scoring systems and filtered through generated blacklists to intelligently test and verify the addresses. These systems may be an Internet site, website, application, software or more, and might be on a computer, smart phone, tablet or other user device and may be published in whole or in part or in summary in the system(s).

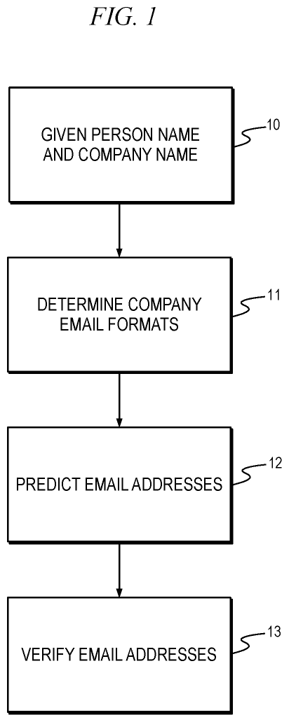

FIG. 1 shows an overview of the basic flow chart. The initial step is the provision of personal and company names 10. The system then determines the email formats for the company 11 and predicts the email address(es) 12. Finally, the predicted email address(es) are verified 13.

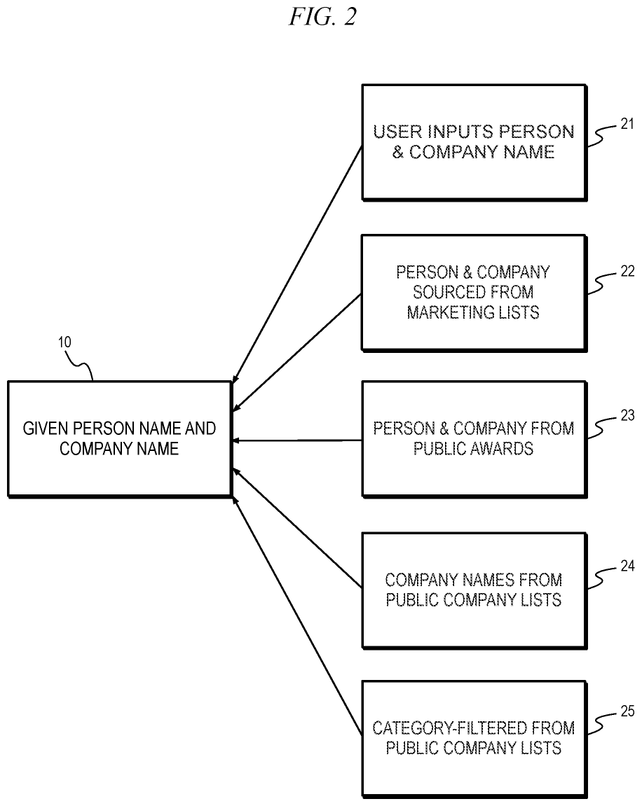

FIG. 2 shows detailed steps to attain person and company names. There are many ways to obtain person and company names. One familiar with the art could find additional ways to determine the name of a person and his employer. One way is that the person and company name is input by a user of a social or market network 21. Another method is to acquire lists of prospective users from lists of people in business, sport, entertainment or other marketing lists 22. Alternatively, person and company names are acquired from public reports of awards and other significant achievements in the fields of interest appropriate to the social network 23. In this case these may be multiple company names that the person could be part of and it may be necessary to find the current company name. This often can be determined using online searches of a person with a company to determine their current company. If several company matches are made with the person, then these can all be tested later during verification. A further source of company names may include public company lists 24. In this case it may be necessary to find all the people in a company. As before, this can be determined using third-party on line searches to locate people and match with the company name. A variation on this method is where filtering by category is carried out 25. Category could be the title, industry, or department, etc. Another variation is where the person's current title is found by using third-party searches, and then all people with similar titles in the company can be selected and verified. Thus, embodiments advantageously leverage aggregate knowledge to instrument success rate.

In some embodiments, one can use the presence and/or prevalence of certain titles within a company to predict an industry in which that company is likely to operate. For example, titles such as CCO (Chief Creative Officer), CD (Creative Director), ECD (Executive Creative Director), art director, copywriter, graphic artist, designers, and/or account managers/supervisors would suggest an advertising agency. Titles such as sound, motion, visual effects, and producers would suggest a production company. Titles such as brand manager, vice president of marketing, CMO (Chief Marketing Officer), and marketing manager suggest an advertising client, such as a manufacturer or merchant of consumer goods. Predicting a company's role (e.g., the industry in which it operates) can constrain the search space and thus reduce the number of wrong guesses and false positives.

In some embodiments, the number of candidate companies can also be reduced by confirming details about a user on a market network or other social network profile. For example, some embodiments may be able to handle page layouts fed to a Google® bot. An embodiment may require the predicted current company for a user to match the current company displayed on that user's market network (e.g., Shocase® or LinkedIn®) profile, otherwise the predicted current company is abandoned and replaced with that shown on the user's market network profile. An embodiment may also save the user's current profile picture from one social network (e.g., LinkedIn®) and use it as a default profile picture when setting up a page for that user on another social network (e.g., Shocase®).

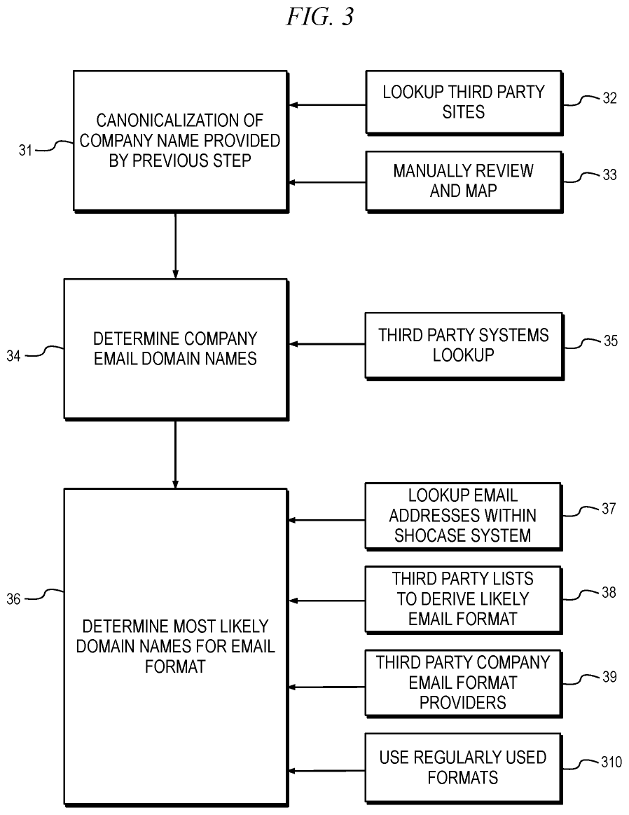

FIG. 3 shows the steps to determine the email formats for the company. First, the company name that is provided in the previous step needs to be canonicalized 31 to the official company name. Canonicalization is the process of identifying several representations of the same entity for equivalence and converting that data into a standard form. For example, IBM® and International Business Machines Corporation™ are one entity and IBM® NZ Ltd and IBM® New Zealand are another entity. A person that works for IBM® New Zealand could be using an email address that is for either or both entities. As another example, the advertising agency BBDO's Atlanta office has a web page at bbdoat1.com but an email domain of bbdo.com. Thus, it may be necessary to first find a company's web domain, then find the company's email domain. The canonicalization of company names can be performed using third-party sites 32, such as Wikipedia®, Google®, Yahoo!®, etc., or by manually reviewing names 33 and mapping these to the official company name.

IBM® and International Business Machines™ are trademarks of International Business Machines, Armonk, N.Y. Wikipedia® is a trademark of Wikimedia Foundation, San Francisco, Calif. Google® is a trademark of Google Inc., Mountain View, Calif. Yahoo!® is a trademark of Yahoo! Inc., Sunnyvale, Calif.

There may be a process of mapping input companies to canonical names, which can then be used to find an email domain by looking in a database of companies. An example of an industry-specific database is Advertising REDBOOKS™ and redbooks.com™, both of which are trademarks of Red Books LLC, Summit, N.J. A more generally-applicable database is D&B®, which is a trademark of Dun & Bradstreet, Inc., Short Hills, N.J.

When using third-party sites to find domains of companies or other entities with which an individual may be associated, it may be desirable to maintain a blacklist of sites which should be excluded. This blacklist may include, for example, competing social and/or market networks. More generally, the blacklist may include websites which are more likely to represent an individual's personal and/or professional profile and/or portfolio than an individual's primary and/or preferred means of communication and/or contact for personal and/or professional purposes. Types of sites which one may wish to blacklist may include, for example, archives of prior work, lists of past credits and/or collaborators, job boards, freelance marketplaces, lists of companies in a particular company, news sites, and team-oriented sites. Instead, it may be preferable to focus the search on authoritative sites for domains, such as Wikipedia® or a company's profile page on a market network such as Shocase® or LinkedIn®.

Second, the company's most likely email domain names can be determined using email prediction code to generate possible email address(es) based on evidence 34. This can be done by automated searches for contact page, scanning for email addresses in contacts and scanning email domain names using third-party systems 35, such as domain registration providers, Google®, Yahoo!® etc. The most likely domain names are then determined 36. Third, there are multiple ways to derive likely company email formats. Email addresses that are in the local system 37 or in third-party lists 38, using third-party systems that provide email formats for companies 39 or using regularly used formats, such as first.last@company.com, flast@company.com, first@company.com, etc. 310. Reduction of the number of candidate company email formats can be achieved by confirming details about a user searching online profiles, contact lists, or during the verification stage.

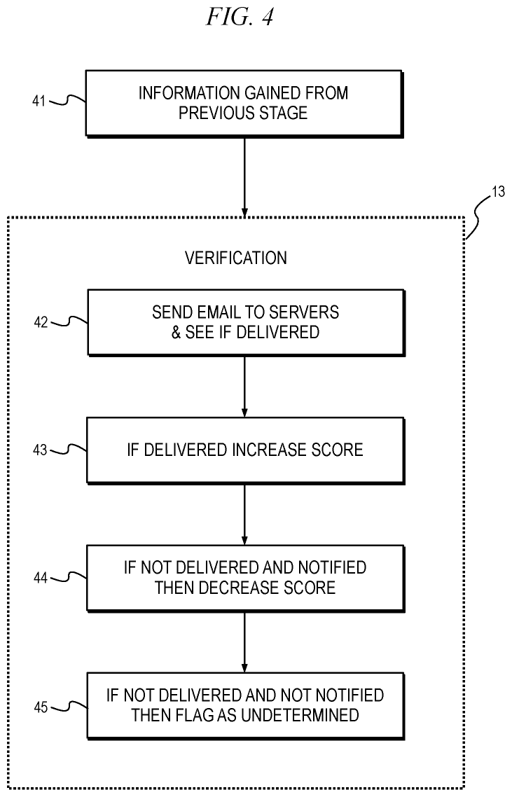

FIG. 4 shows the final email prediction and verification stages that determine the most likely email formats and company domain names, and score these. The highest scores are most likely. Once the previous steps have been completed, a number of email addresses can be predicted for the person 41 which can then be used to verify most likely email formats 13. Email is sent to the SMTP (Simple Mail Transfer Protocol) servers to see if it gets delivered 42. If the email is delivered then that company email address format has its score increased 43. Eventually, the delivered email list can be used to confirm the mapping. If the email is not delivered and a notification is received then the score for that company email format and domain name is decreased 44. If the email is not delivered and no notification is received then an ‘undetermined’ flag is added 45 to that company email format and domain name.

Thus, an embodiment of the present invention may include a digital system that implements the method described above to perform combinations of the above steps, based on the available data inputs, to predict a valid email address. Each step of the method may store the input and output available data, and may record when and which run of the system generated the new data. This way it may be possible to go back and “uncommit” a run, or continue the run of the pipeline if it stopped at some point (e.g. because more input data was required). Additionally the system can re-execute the method once the company email format and domain name scores have been increased, so as to improve the accuracy of the predicted emails for everyone at a company.

Accordingly, an illustrative embodiment may offer improved resiliency. For example, an embodiment may either recover from failures or abort an entire entry, rather than making guesses on partial data. An embodiment may also mark dead nodes and remove them from the set of candidates. An embodiment may also advantageously instrument the success rate of a verified email domain and/or a current company.

An illustrative embodiment may utilize a querying (e.g., testing) infrastructure using open-source and/or commercially-available software including, but not limited to, an implementation of SMTP (Simple Mail Transport Protocol) as defined in, for example, Internet Engineering Task Force (IETF) Internet Standard (STD) 10, as well as Request for Comments (RFC) 2821 and 5321, the disclosures of which are incorporated by reference herein. An illustrative embodiment may interface with third-party online platforms, such as Google® (including but not limited to Gmail); LinkedIn® (including but not limited to Rapportive™); and/or MailTester.com. Google® and Gmail® are trademarks of Google Inc., Mountain View, Calif. LinkedIn® and Rapportive™ are trademarks of LinkedIn Corporation, Mountain View, Calif. MailTester.com is offered by Brecht Sanders of Edustria, Beerst, Belgium.

However, it may also be desirable to reduce dependency on third-party software by instead increasing use of internal SMTP verification. By executing verification at the nodes, one can reduce the gap between external interfaces (e.g., MailTester.com) and internal components, thereby improving verification logic. For example, an illustrative embodiment can implement email set-up and tear-down, and can also add compose email verification.

That said, having an external interface available can improve reliability and scalability. Thus, it may be desirable to implement an intelligent failover switch to an external interface, such as MailTester.com. Moreover, Rapportive™ offers approximately 10-15% greater email verification over SMTP. However, some features of Rapportive™ have been disabled since it was acquired by LinkedIn®, and its future is even more unclear in view of the recently-announced acquisition of LinkedIn® by Microsoft®. Thus, it may be desirable to reverse-engineer a plug-in having functionality to prior versions of Rapportive™.

Embodiments may also implement one or more additional improvements to the aforementioned querying infrastructure. For example, the infrastructure could be made horizontally scalable by executing work on slave nodes. An exemplary querying infrastructure could advantageously reduce the latency associated with spooling up slave processes and/or systems, such as by spinning up proxies concurrently rather than serially. Additionally and/or alternatively, one can spin up extra proxies to improve reliability and resiliency: e.g., spin up N+2 proxies, but only take the first N proxies. Appropriate adjustments can also be made to the firewall on a proxy master and/or slaves.

An embodiment may improve resiliency by implementing an incremental reset. For example, an embodiment may perform a “smoke test” (e.g., a high-level test of basic operability) of each service, then reset bad nodes individually based on the results of the “smoke test.” Additionally and/or alternatively, an embodiment may provide enhanced query failure recovery features. For example, when LinkedIn® detects “unusual traffic,” such as attempts to gain direct access outside of the LinkedIn® API (application program interface), LinkedIn® returns error code 999, which is not defined in the HTTP (HyperText Transport Protocol) standard. An illustrative embodiment handles these non-standard 999 error codes, including recovery functionality from multiple such error codes.

An illustrative embodiment of the present invention provides a system of steps that can be used in combination to predict company email address formats and users' company email addresses. Unique software algorithms are employed to intelligently analyze and compare data from a variety of sources (both local to the system and third-party) in order to determine and verify company email addresses for prospective users of a social network system.

Given the discussion thus far, it will be appreciated that, in general terms, an exemplary method, according to an aspect of the invention, includes a step of obtaining an identifier of an individual, wherein the individual is associated with at least one entity such that the individual has an email address in a domain corresponding to the entity. The method also includes a step of determining one or more candidate domains such that: the one or more candidate domains potentially correspond to the at least one entity; and the individual potentially has the email address in at least one of the one or more candidate domains. The method further includes a step of determining one or more candidate email addresses in at least one of the one or more candidate domains, wherein the one or more candidate email addresses comprises the email address which the individual potentially has in the at least one of the one or more candidate domains. The method additionally includes a step of testing the one or more candidate email addresses and the one or more candidate domains to determine the email address of the individual in the domain corresponding to the entity.

By way of example, the entity may be a company and the individual may be an employee of the company. As another example, the entity may be a social network and the individual may be a user of the social network. The identifier of the individual may include at least one of a name, a title, an industry, a department, an award, and an achievement.

Obtaining an identifier of an individual may include: obtaining the identifier of the individual and an identifier of the entity; and canonicalizing at least one of the identifier of the individual and the identifier of the entity; wherein the identifier of the entity is other than the domain corresponding to the entity; and wherein the identifier of the individual is other than the email address of the individual at the domain corresponding to the entity. Additionally and/or alternatively, the method may also include, after obtaining the identifier of the individual, determining the at least one entity at least in part by using the identifier of the individual to search at least one internal data source and at least one external data source.

Determining one or more candidate domains may include determining a plurality of entities with which the individual is associated such that the individual has a plurality of email addresses in respective domains corresponding to respective entities with which the individual is associated; and determining the one or more candidate domains based at least in part on the domains corresponding to respective entities with which the individual is associated. The individual may have a plurality of active email addresses in respective domains corresponding to respective entities with which the individual is associated. Additionally and/or alternatively, the plurality of entities may include at least one entity with which the individual is no longer associated, wherein at least one of the plurality of email addresses is in at least one domain corresponding to the at least one entity with which the individual is no longer associated, wherein at least one of: the at least one domain is no longer active and the at least one of the plurality of email addresses is no longer active. Determining the one or more candidate domains may additionally and/or alternatively include determining at least one entity with which the individual is currently associated; and determining the one or more candidate domains corresponding to the at least one entity with which the individual is currently associated.

Determining one or more candidate email addresses in at least one of the one or more candidate domains may include determining at least one formatting rule which, when applied to an identifier of a given individual, determines at least one of the one or more candidate email address of the given individual in the at least one of the one or more candidate domains; and in the at least one of the one or more candidate domains, applying the at least one formatting to the identifier of the individual to obtain at least one of the one or more candidate email addresses. The at least one formatting rule may be determined based at least in part by comparing on respective email addresses of one or more other individuals associated with the entity with respective identifiers of the one or more other individuals associated with the entity.

Testing the one or more candidate email addresses and the one or more candidate domains may include the steps of sending an email message to a given candidate email address in a given candidate domain; determining whether the email message was delivered to the individual at the entity; if the email message was not delivered to the individual at the entity, determining at least one of the given candidate domain and the given candidate email address to be erroneous; and if the email message was delivered to the individual at the entity, determining the given candidate email address in the given candidate domain to be the email address of the individual in the domain corresponding to the entity. Determining whether the given candidate domain or the given candidate email address is erroneous is based at least in part on at least one of an existence and a content of a notification received in response to the email message.

Determining at least one of the given candidate domain and the given candidate email address to be incorrect if the email message was not delivered to the individual at the entity may include: after sending the email message to the given candidate email address in the given candidate domain, determining whether the email message was delivered to the given candidate domain; if the email message was not delivered to the given candidate domain, determining that the email message was not delivered to the individual at the entity at least because the given candidate domain is erroneous; if the email message was delivered to the given candidate domain, determining whether the email message was delivered to the given candidate email address at the given candidate domain; if the email message was not delivered to the given candidate email address at the given candidate domain, determining that the email message was not delivered to the individual at the entity at least because the given candidate email address is erroneous; and if the email message was delivered to the given candidate email address at the given candidate domain, determining whether the email message was delivered to the individual at the entity.

As previously mentioned, illustrative embodiments may include an exemplary computer system which uses software algorithms to perform one or more combination of steps discussed in the preceding paragraphs and in the claims below. Examples of such systems may include a computer, smart phone, tablet or other user device. The computer may utilize software, including but not limited to an Internet site, website, or other application, which may be published in whole or in part or in summary in the system(s).

Based on the foregoing, it is implicit and/or inherent that one or more embodiments of the invention or elements thereof can be implemented in the form of a computer program product including a computer readable storage medium with computer usable program code for performing the method steps indicated. Also based on the foregoing, it is implicit and/or inherent that one or more embodiments of the invention or elements thereof can be implemented in the form of a system (or apparatus) including a memory, and at least one processor that is coupled to the memory and operative to perform exemplary method steps. Similarly, it is implicit and/or inherent that one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

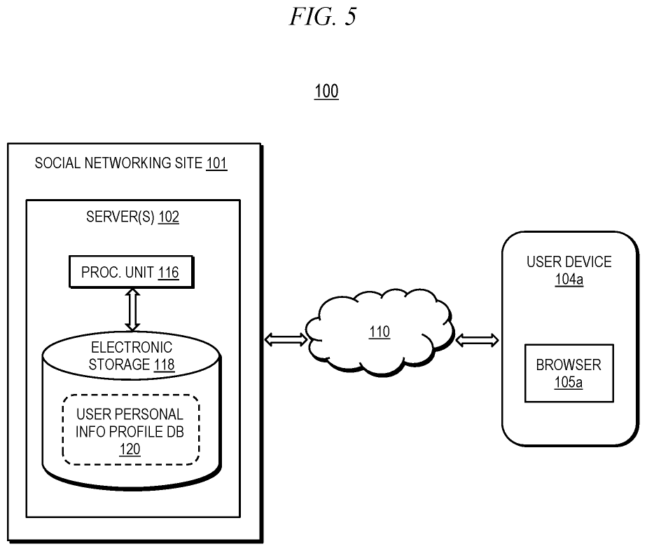

FIG. 5 depicts a general overview of an Internet-accessible social network site system 100, in accordance with various aspects of the present disclosure. The platform of system 100 includes social networking website 101 that is hosted by server (or servers) 102, which are configured to communicate with, and process information from, remotely-situated user communication device(s) 104 a via a communication facility, such as, for example, the Internet 110.

Server(s) 102 may embody one or more computing devices incorporating hardware components, operating systems, and programming languages that may be familiar to those skilled in the art in order to implement the processing as described herein. The computing devices may include one or more memory storage devices, such as, electronic storage device(s) 118 as well as one or more physical processing units 116 programmed with one or more computer program instructions to perform the functionality of social networking website 101, in addition to other components. As such, processing unit(s) 116 may embody one or more of a digital processor, analog processor, digital circuit designed to process information, analog circuit designed to process information, a state machine, and/or other mechanisms for electronically processing information. In some implementations, processing unit(s) 116 may include a plurality of processors that are physically located within the same computing device or may represent processing functionality of a plurality of devices operating in coordination.

The computing devices may also include communication module(s) designed to establish the communication and accommodate the exchange of information between social networking website 101 and user device(s) 104 and/or other computing platforms via the communication facility, such as, the Internet 110. The computing devices may further include a plurality of hardware, software, and/or firmware components operating together to provide the functionality attributed herein to server(s) 102. For example, the computing devices may be implemented by a cloud of computing platforms communicating and operating together.

As noted above, server(s) 102 may include memory storage devices, such as, electronic storage device(s) 118, which may store software algorithms, information generated by processing units 116, information received from other server(s) 102, information received from other computing platforms, or other information that enables the server(s) 102 to function as described herein. In particular, with regard to server(s) 102 of social networking website 101, electronic storage device(s) 118 may be configured to store information related to users, such as, for example, user-guided, pre-populated personal information profiles in database(s) 120. The database(s) 120 may include, or interface with, for example, an Oracle® relational database, Informix®, DB2® (Database 2) or other data storage, including file-based, or query formats, platforms, or resources such as OLAP (On Line Analytical Processing), SQL (Structured Query Language), a SAN (Storage Area Network), Microsoft® Access® or others may also be used, incorporated, or accessed. It will be appreciated that database(s) 120 may comprise one or more such databases that reside in one or more physical devices and in one or more physical locations. The database(s) 120 may be configured to store a plurality of types of data and/or files and associated data or file descriptions, administrative information, or any other data.

Oracle® is a trademark of Oracle International Corporation, Redwood City, Calif. Informix® and DB2® are trademarks of International Business Machines, Armonk, N.Y. Microsoft®, Access®, and Microsoft Access® are trademarks of Microsoft Corporation, Redmond, Wash.

Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A method comprising the steps of:
obtaining an identifier of an individual, wherein the individual is associated with at least one entity such that the individual has an email address in a domain corresponding to the entity;
determining one or more candidate domains such that:
the one or more candidate domains potentially correspond to the at least one entity; and
the individual potentially has the email address in at least one of the one or more candidate domains;
determining one or more candidate email addresses in at least one of the one or more candidate domains, wherein the one or more candidate email addresses comprises the email address which the individual potentially has in the at least one of the one or more candidate domains; and
testing the one or more candidate email addresses and the one or more candidate domains to determine the email address of the individual in the domain corresponding to the entity.

2. The method of claim 1, wherein the entity comprises a company and the individual is an employee of the company.

3. The method of claim 1, wherein the entity comprises a social network and the individual is a user of the social network.

4. The method of claim 1, wherein the identifier of the individual comprises at least one of a name, a title, an industry, a department, an award, and an achievement.

5. The method of claim 1, wherein obtaining an identifier of an individual comprises:
obtaining the identifier of the individual and an identifier of the entity; and
canonicalizing at least one of the identifier of the individual and the identifier of the entity;
wherein the identifier of the entity is other than the domain corresponding to the entity; and
wherein the identifier of the individual is other than the email address of the individual at the domain corresponding to the entity.

6. The method of claim 1, further comprising the step of, after obtaining the identifier of the individual, determining the at least one entity at least in part by using the identifier of the individual to search at least one internal data source and at least one external data source.

7. The method of claim 1, wherein determining one or more candidate domains comprises:
determining a plurality of entities with which the individual is associated such that the individual has a plurality of email addresses in respective domains corresponding to respective entities with which the individual is associated; and
determining the one or more candidate domains based at least in part on the domains corresponding to respective entities with which the individual is associated.

8. The method of claim 7, wherein the individual has a plurality of active email addresses in respective domains corresponding to respective entities with which the individual is associated.

9. The method of claim 7, wherein the plurality of entities comprises at least one entity with which the individual is no longer associated, wherein at least one of the plurality of email addresses is in at least one domain corresponding to the at least one entity with which the individual is no longer associated, wherein at least one of:
the at least one domain is no longer active; and
the at least one of the plurality of email addresses is no longer active.

10. The method of claim 1, wherein determining the one or more candidate domains comprises:
determining at least one entity with which the individual is currently associated; and
determining the one or more candidate domains corresponding to the at least one entity with which the individual is currently associated.

11. The method of claim 1, wherein determining one or more candidate email addresses in at least one of the one or more candidate domains comprises:
determining at least one formatting rule which, when applied to an identifier of a given individual, determines at least one of the one or more candidate email address of the given individual in the at least one of the one or more candidate domains; and
in the at least one of the one or more candidate domains, applying the at least one formatting to the identifier of the individual to obtain at least one of the one or more candidate email addresses.

12. The method of claim 11, wherein the at least one formatting rule is determined based at least in part by comparing on respective email addresses of one or more other individuals associated with the entity with respective identifiers of the one or more other individuals associated with the entity.

13. The method of claim 1, wherein testing the one or more candidate email addresses and the one or more candidate domains comprises the steps of:
sending an email message to a given candidate email address in a given candidate domain;
determining whether the email message was delivered to the individual at the entity;
if the email message was not delivered to the individual at the entity, determining at least one of the given candidate domain and the given candidate email address to be erroneous; and
if the email message was delivered to the individual at the entity, determining the given candidate email address in the given candidate domain to be the email address of the individual in the domain corresponding to the entity.

14. The method of claim 13, wherein determining whether the given candidate domain or the given candidate email address is erroneous is based at least in part on at least one of an existence and a content of a notification received in response to the email message.

15. The method of claim 13, wherein determining at least one of the given candidate domain and the given candidate email address to be incorrect if the email message was not delivered to the individual at the entity comprises the steps of:
after sending the email message to the given candidate email address in the given candidate domain, determining whether the email message was delivered to the given candidate domain;
if the email message was not delivered to the given candidate domain, determining that the email message was not delivered to the individual at the entity at least because the given candidate domain is erroneous;
if the email message was delivered to the given candidate domain, determining whether the email message was delivered to the given candidate email address at the given candidate domain;
if the email message was not delivered to the given candidate email address at the given candidate domain, determining that the email message was not delivered to the individual at the entity at least because the given candidate email address is erroneous; and
if the email message was delivered to the given candidate email address at the given candidate domain, determining whether the email message was delivered to the individual at the entity.

16. The method of claim 6, wherein the at least one internal data source and the at least one external data source each comprise a respective social network.

17. The method of claim 16, wherein the at least one internal data source and the at least one external data source each comprise a respective market network.

18. The method of claim 1, wherein:
the entity has a plurality of domains corresponding thereto;
the entity has at least one website in at least a first domain of the plurality of domains corresponding to the entity;
the individual has the email address in at least a second domain of the plurality of domains corresponding to the entity;
the step of determining the one or more candidate domains comprises, based at least in part on the first domain corresponding to the entity, determining the second domain corresponding to the entity; and
the one or more candidate domains comprises the second domain corresponding to the entity rather than the first domain corresponding to the entity.

19. A system comprising:
a non-transitory storage medium having software embodied therewith; and
at least one computer coupled to the non-transitory storage medium;
wherein the at least one computer is operative:
to obtain an identifier of an individual, wherein the individual is associated with at least one entity such that the individual has an email address in a domain corresponding to the entity;
to determine one or more candidate domains such that:
the one or more candidate domains potentially correspond to the at least one entity; and
the individual potentially has the email address in at least one of the one or more candidate domains;
to determine one or more candidate email addresses in at least one of the one or more candidate domains, wherein the one or more candidate email addresses comprises the email address which the individual potentially has in the at least one of the one or more candidate domains; and
to test the one or more candidate email addresses and the one or more candidate domains to determine the email address of the individual in the domain corresponding to the entity.

20. A non-transitory storage medium having software embodied therewith configured:
to obtain an identifier of an individual, wherein the individual is associated with at least one entity such that the individual has an email address in a domain corresponding to the entity;
to determine one or more candidate domains such that:
the one or more candidate domains potentially correspond to the at least one entity; and
the individual potentially has the email address in at least one of the one or more candidate domains;
to determine one or more candidate email addresses in at least one of the one or more candidate domains, wherein the one or more candidate email addresses comprises the email address which the individual potentially has in the at least one of the one or more candidate domains; and
to test the one or more candidate email addresses and the one or more candidate domains to determine the email address of the individual in the domain corresponding to the entity.
